(19) United States
(12) Patent Application Publication
(10) Pub. No.: US 2019/0377804 A1
(43) Pub. Date: Dec. 12, 2019

(54) DATA COMPRESSION ALGORITHM

(71) Applicant: Yingquan Wu, Palo Alto, CA (US)

(72) Inventor: Yingquan Wu, Palo Alto, CA (US)

(21) Appl. No.: 16/160,699

(22) Filed: Oct. 15, 2018

Related U.S. Application Data
(60) Provisional application No. 62/681,595, filed on Jun. 6, 2018.

(51) Int. Cl. G06F 17/30

(52) U.S. Cl. CPC G06F 17/30153; G06F 17/30979

(57) ABSTRACT

A method for augmenting a dictionary of a data compression scheme. For each input string, the result of a sliding window search is compared to the result of a dictionary search. The dictionary is augmented with the sliding window search result if the sliding window search result is longer than the dictionary search result. An embodiment of the disclosure implements multiple sliding windows, each sliding window having an associated size, the size of sliding window dependent on a corresponding match length. For one embodiment, each sliding window has a corresponding hash function based upon the match length.

### BACKGROUND

This disclosure relates generally to the field of data transmission and storage, and more specifically to data compression and decompression.

In digital systems, data may be compressed to save storage costs or to reduce transmission time. A wide variety of digital data signals (e.g., data files, documents, images, etc.) may be compressed. By decreasing the required memory for data storage and/or the required time for data transmission, compression can yield improved system performance and a reduced cost.

Some well-known and widely used, lossless, compression schemes employ dictionary-based compression which uses the fact that many data types contain repeating sequences of characters. One conventional algorithm. LZ77, achieves compression by replacing repeated occurrences of data with references to a single copy of that data existing earlier in the uncompressed data stream. The recurring data (string match) is encoded by a pair of numbers called a length-distance pair, which is equivalent to the statement “each of the next length characters is equal to the characters exactly distance characters behind it in the uncompressed stream.” The “distance” is sometimes called the “offset” instead.

To spot string matches, the encoder must keep track of some amount of the most recent data, such as, for example, the most recent 32 kB of data. The structure in which this data is held is called a sliding window. The encoder uses this data to search for string matches, and the decoder uses this data to interpret the matches which the encoder refers to. The larger the sliding window is, the longer back the encoder may search for creating references.

So, to effect compression, the encoder searches the data contained in the sliding window to find the longest string that matches a string starting at the present position in the input stream. The encoder performs a hashing function on some unit of data at the present position and one or more subsequent units of data in the input stream, and uses the resulting hash as an index into a hash table that includes, for each hash, a set of pointers that point to other strings in the history buffer that produced the same hash.

LZ78 algorithms achieve compression by replacing repeated occurrences of data with references to a dictionary that is built based on the input data stream. Each dictionary entry is of the form dictionary[ . . . ]=(index, character), where index is the index to a previous dictionary entry, and character is appended to the string represented by dictionary [index]. For example, “abc” would be stored (in reverse order) as follows: dictionary[k]={j, ‘c’}, dictionary[j]={i, ‘b’}, dictionary [i]={0, ‘a’}, where an index of 0 specifies the first character of a string.

The algorithm initializes last matching index=0 and next available index=1. For each character of the input stream, the dictionary is searched for a match: {last matching index, character}. If a match is found, then last matching index is set to the index of the matching entry, and nothing is output. If a string match is not found, then a new dictionary entry is created: dictionary [next available index]={last matching index, character}, and the algorithm outputs last matching index, followed by character, then resets last matching index=0 and increments next available index.

LZW is an LZ78-based algorithm that uses a dictionary pre-initialized with all possible characters (symbols) or emulation of a pre-initialized dictionary. The main improvement of LZW is that when a match is not found, the current input stream character is assumed to be the first character of an existing string in the dictionary (since the dictionary is initialized with all possible characters), so only the last matching index is output (which may be the pre-initialized dictionary index corresponding to the previous, or the initial, input character). To decode an LZW-compressed data, the decoder requires access to the initial dictionary used. Additional entries can be reconstructed from previous entries.

Generally, dictionary-based compression methods use the principle of replacing substrings in a data stream with a codeword that identifies that substring in a dictionary. This dictionary can be static if knowledge of the input stream and statistics are known or can be adaptive. Adaptive dictionary schemes are better at handling data streams where the statistics are not known or vary.

There are disadvantages to each of the conventional dictionary based, sliding-window, compression techniques. For example, it may be beneficial to compress some data types using an LZ78-type dictionary (e.g., LZW); the compression of other data types may be more efficient using an LZ77 string match.

Also, while a larger sliding window will typically yield more and longer matches, in both software and hardware, increasing the size of the sliding window may be more expensive in terms of implementation costs or reduced performance. For example, the sliding window may be stored in specialized memory such as a content addressable memory which requires more circuits to implement as compared to standard memory.

Additionally, a larger sliding window may render storing references for smaller matches inefficient. Further, typical dictionary-based schemes are inherently serial and do not make use of the parallel processing available in many processor architectures resulting in decreased performance.

It is within the aforementioned context that a need for the present disclosure has arisen. Thus, there is a need to address one or more of the foregoing disadvantages of conventional systems and methods, and the present disclosure meets this need.

### BRIEF SUMMARY

Various aspects of a method for augmenting a dictionary of a data compression scheme can be found in exemplary embodiments of the present disclosure.

In one embodiment of the disclosure, for each input string, the result of a sliding window search is compared to the result of a dictionary search. The dictionary is augmented with the sliding window search result if the sliding window search result is longer than the dictionary search result. Another embodiment of the disclosure implements multiple sliding windows, each sliding window having an associated size, the size of sliding window dependent on a corresponding match length. For one embodiment, each sliding window has a corresponding hash function based upon the match length.

A further understanding of the nature and advantages of the present disclosure herein may be realized by reference to the remaining portions of the specification and the attached drawings. Further features and advantages of the present disclosure, as well as the structure and operation of various embodiments of the present disclosure, are described in detail below with respect to the accompanying drawings. In the drawings, the same reference numbers indicate identical or functionally similar elements.

### BRIEF DESCRIPTION OF THE DRAWINGS

FIG. 1 illustrates a process for providing a dictionary for a sliding window compression scheme in accordance with one embodiment of the disclosure:

FIG. 2 illustrates a match length dependent multiple sliding window compression scheme in accordance with one embodiment of the disclosure;

FIG. 3 illustrates a match length dependent multiple sliding window compression scheme in accordance with one embodiment of the disclosure; and

FIG. 4 illustrates a computing device which may be used to perform processes in accordance with various embodiments of the disclosure.

### DETAILED DESCRIPTION

Reference will now be made in detail to the embodiments of the disclosure, examples of which are illustrated in the accompanying drawings. While the disclosure will be described in conjunction with the embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth to provide a thorough understanding of the present disclosure. However, it will be obvious to one of ordinary skill in the art that the present disclosure may be practiced without these specific details. In other instances, well-known methods, procedures, components, and circuits have not been described in detail as to not unnecessarily obscure aspects of the present disclosure. Moreover, inventive aspects lie in less than all features of a single disclosed embodiment. Thus, the claims following the Detailed Description are hereby expressly incorporated into this Detailed Description, with each claim standing on its own as a separate embodiment of this disclosure.

Systems and methods are disclosed for an improved dictionary-based compression algorithm. An embodiment of the disclosure provides a method for string searching and augmenting a dictionary of a data compression scheme. For each input string, the result of a sliding window search is compared to the result of a dictionary search. The dictionary is augmented with the sliding window search result if the sliding window search result is longer than the dictionary search result. An embodiment of the disclosure implements multiple sliding windows, each sliding window having an associated size, the size of sliding window dependent on a corresponding match length. For one embodiment, each sliding window has a corresponding hash function based upon the match length.

Embodiments of the disclosure are applicable in a variety of settings in which data compression or decompression is affected.

### Matched String Dictionary

Various alternative embodiments of the disclosure provide systems and methods for creating a dictionary for a dictionary-based compression scheme using a sliding window match length search to determine dictionary entries.

As discussed above, LZ77 compression employs a match string search over a sliding window and once the longest match is determined, the match is encoded using a length-distance pair. Since, the typical sliding window size is 32 KB, the minimum match length is typically set to three bytes to effect compression by encoding as a (length, distance) pair. During LZ77 compression, it may be likely that recently matched strings will recur. It is more efficient to compress such recurrences as a dictionary entry than as multiple (length, distance) pairs. Therefore, a dictionary that includes recently matched strings may provide greater compression efficiency as the encoding of the match string as (dictionary indicator, dictionary index) is likely to be shorter. This is because, when dictionary is used often to determine match strings, the indicator is expressed with shorter length by entropy encoding (e.g., Huffman encoding). Further, employing a dictionary that includes recently matched strings may result in determining the longest match quicker. Additionally, the augmented dictionary enables the string match search beyond the sliding window.

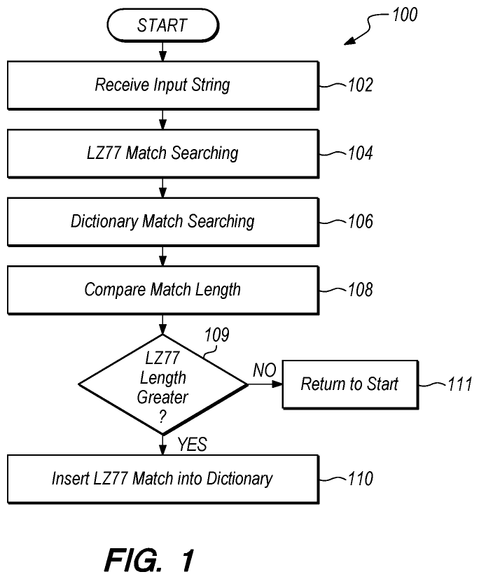

FIG. 1 illustrates a process for providing a dictionary for a sliding window compression scheme in accordance with one embodiment of the disclosure.

As shown in FIG. 1, process 100 begins at operation 102 in which a data string is received. At operation 104 a search is performed over a sliding window (typically 32 KB), as discussed above in reference to the LZ77 compression algorithm, and the longest matched string length is determined. At operation 106, a dictionary search is performed to determine the length of the longest dictionary match. At operation 108 the matched string length is compared to the length of the dictionary match.

At operation 109, if the matched string length is greater than the dictionary match length, then a dictionary entry referencing the match string is added to the dictionary at operation 110. For various embodiments of the disclosure, the matched string is added to the dictionary in accordance with conventional dictionary-based compression scheme processes. If the matched string length is not greater than the dictionary match length, then the input data string is encoded as the matching dictionary entry at operation 111 and the process is reiterated with a subsequent input data string.

In accordance with an aspect of the disclosure, the matched string is only added to the dictionary if it is longer than the dictionary match. Therefore, the dictionary is comprised of matched strings only. In contrast to prior art dictionary-based compression methods which create dictionary entries for any strings not already in the dictionary, embodiments of the disclosure create a dictionary entry only if the string is identified as the longest match through a sliding window string match search. This may result in faster more efficient compression. Upon decompression the decoder repeats the dictionary building process of the encoder, by creating dictionary entries based upon the match results and therefore recreates the same dictionary used for compression.

### Multiple Match Length Dependent Sliding Windows

As noted above, sliding window compression schemes such as LZ77 implement a single sliding window to keep track of a fixed amount of the most recent data stream input. The sliding window size may be for example 2 KB, 4 KB, or 32 KB. A smaller sliding window size allows for efficiently encoding smaller matches while a larger sliding window size typically results in longer matches. Some LZ77-based algorithms such as DEFLATE and GZIP use a 32 KB sliding window. Such algorithms require 23 bits to encode a match as an (offset, length) pair, using 15 bits for offset and 8 bits for length. Thus, for 32 KB sliding window it is futile to encode matches of less than three bytes. Enlarging the sliding window size to increase the likelihood of identifying longer matches would render encoding of even longer matches (e.g., 3-byte matches) inefficient.

For example, consider a hash function of i byte-wise characters denoted by H₁, A 32 KB sliding window compression scheme would have a 3-byte minimum match length and therefore a hash function H₃ would be used. If the data stream included a match with length of 4 bytes at an offset of 16 KB and a match with length 12 bytes at an offset of 48 KB (i.e. outside the sliding window), then the longest identified match would be the 4-byte match at offset 16 KB. If the sliding window size is increased in order to locate longer matches then the minimum efficient match length is increased.

Embodiments of the disclosure may implement multiple sliding windows of different sizes; the sizes being based upon the match length. Embodiments of the disclosure may also create a corresponding hashing function for each sliding window size implemented.

Embodiments of the disclosure encompass all combinations of sliding window size and match length which render the match length effectively compressible. For one embodiment, seven sliding window sizes each with corresponding match length are implemented. The match pair is in the form of length-offset so, upon decompression the decoder employs the corresponding, length-dependent, sliding window.

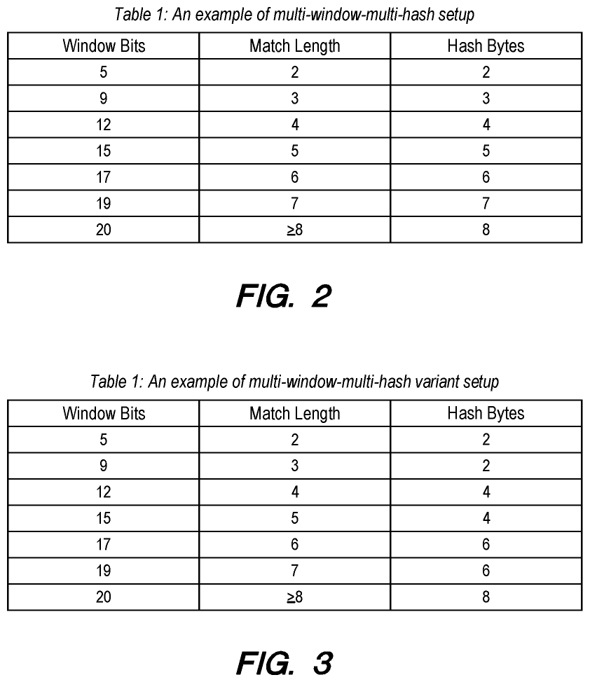

FIG. 2 illustrates a match length dependent multiple sliding window compression scheme in accordance with one embodiment of the disclosure.

As shown in FIG. 2, a match length of 2 bytes has a sliding window size corresponding to 5 bits; a match length of 3 bytes has a sliding window size corresponding to 9 bits: a match length of 4 bytes has a sliding window size corresponding to 12 bits; a match length of 5 bytes has a sliding window size corresponding to 15 bits; a match length of 6 bytes has a sliding window size corresponding to 17 bits: a match length of 7 bytes has a sliding window size corresponding to 19 bits: and a match length of 8 or more bytes has a sliding window size corresponding to 20 bits. Thus, by limiting the sliding window size based upon the match length, each of the various sized matches are effectively compressible. For example, when a sliding window size corresponding to 5 bits is used, 2-byte matches are compressible.

The match-length dependent multiple sliding window scheme in accordance with various embodiment of the disclosure substantially improves the compression performance as compared to conventional single sliding window schemes. In accordance with various embodiments of the disclosure, compression speed can be increased by implementing a multiple hash function scheme.

To avoid unnecessary searching, a hash chain for each of the multiple sliding window sizes may be implemented for alternative embodiments of the disclosure. For one such embodiment each of the corresponding hash functions takes the input of the minimum match length of characters associated with a particular window size. For example, as shown in FIG. 2, a 2-byte match employs a hash function H₃, whereas an 8-byte or greater match employs a H₈. Therefore, for such an embodiment, the longest match is searched only over the H₈ hash chain and the first exact match suffices for the other hash chains.

### Parallel Processing

The multiple sliding window size-multiple hash function scheme in accordance with various embodiments of the disclosure is amenable to multi-core environments since each hash chain search may be carried out independently and in parallel. Since the match length is proportional to the sliding window size, each of the several hash chains may be comparable in length and therefore amenable to parallel processing. For example, one core may be assigned to determine the longest match over the H₈ hash chain for the 20-bit sliding window. Another core may be assigned to determine the longest match over the H₇ hash chain for the 19-bit sliding window. Another core may be assigned to determine the longest match over the H₆ hash chain for the 18-bit sliding window. Another core may be assigned to determine the longest match over the H₅ hash chain for the 15-bit sliding window. Another core may be assigned to determine the longest match over the H₄ hash chain for the 12-bit sliding window. Another core may be assigned to determine the longest match over the H₃ hash chain for the 9-bit sliding window. And another core may be assigned to determine the longest match over the H₂ hash chain for the 5-bit sliding window. The multiple parallel searches in accordance with an embodiment of the disclosure result in faster compression by reducing the time to determine the longest match. Further, as noted, because the H₂ hash chain has a sliding window size corresponding to 5 bits, exact two-byte matches are compressible. Therefore, embodiments of the disclosure provide more efficient compression, in contrast prior art schemes that implemented multi-hashing without multiple corresponding size sliding windows.

### Sequential Processing

If the search is conducted sequentially, the search follows the decreasing order of hash bytes until a successful match is determined. For example, in reference to the implementation of FIG. 2, the search starts by determining the longest match over the H₈ hash chain for the 20-bit sliding window: if successful the search is terminated, otherwise the search continues with H₇ hash chain for the 19-bit sliding window to determine the first exact 7-byte match, the process continues over each hash chain/sliding window size combination until a match is determined.

In alternative embodiments of the disclosure, a match length dependent, compression scheme uses a single hash function size for multiple sliding window sizes.

FIG. 3 illustrates match length size and hash function size corresponding to sliding window size in accordance with one embodiment of the disclosure.

In FIG. 3, a hash function size of 2 bytes is used for a match length of 2 bytes having a match length dependent sliding window size of 5 bits. The hash function size of 2 bytes is also used for the match length of 3 bytes having a match length dependent sliding window size of 9 bits. As shown in FIG. 3, other hash functions are used for multiple match length/sliding window size combination as well. This allows the number of hash functions to be reduced where appropriate. As shown in FIG. 3, for such embodiments, the size of the hash function is equal to the minimum match length.

Embodiments of the disclosure have been described as including various operations. Many of the processes are described in their most basic form, but operations can be added to or deleted from any of the processes without departing from the scope of the disclosure. For example, the dictionary match algorithm in accordance with various embodiments of the disclosure may be implemented in conjunction with the match length dependent multiple sliding window scheme or either may be implemented independently of the other.

Embodiments in accordance with the present disclosure may be embodied as an apparatus, method, or computer program product. Accordingly, the present disclosure may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present disclosure may take the form of a computer program product embodied in any tangible medium of expression having computer-usable program code embodied in the medium.

Any combination of one or more computer-usable or computer-readable media may be utilized, including non-transitory media. For example, a computer-readable medium may include one or more of a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. In selected embodiments, a computer-readable medium may comprise any non-transitory medium that can contain, store, communicate, propagate, or transport the program for use by or in connection with the instruction execution system, apparatus, or device.

Computer program code for carrying out operations of the present disclosure may be written in any combination of one or more programming languages, including an object-oriented programming language such as Java, Smalltalk, C++, or the like and conventional procedural programming languages, such as the “C” programming language or similar programming languages. The program code may execute entirely on a computer system as a stand-alone software package, on a stand-alone hardware unit, partly on a remote computer spaced some distance from the computer, or entirely on a remote computer or server. In the latter scenario, the remote computer may be connected to the computer through any type of network, including a local area network (LAN) or a wide area network (WAN), or the connection may be made to an external computer (for example, through the Internet using an Internet Service Provider).

The present disclosure may be described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions or code. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a non-transitory computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

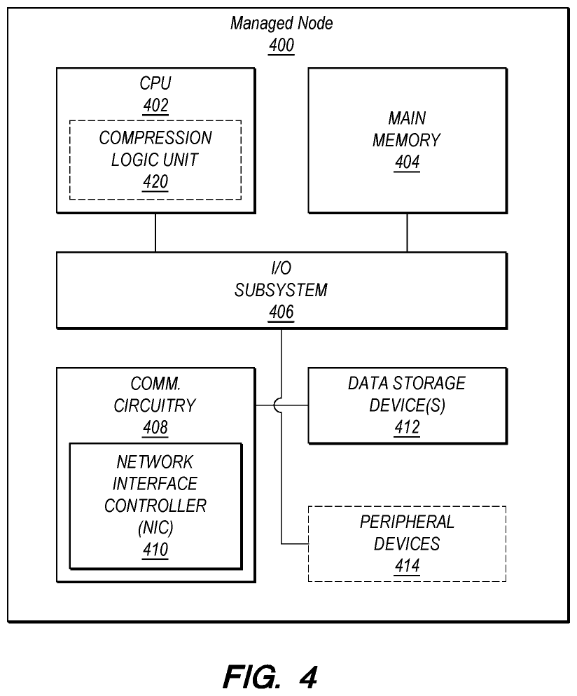

FIG. 4 illustrates a computing device 400 which may be used to perform processes in accordance with various embodiments of the disclosure. Computing device 400 can function as a server, a client, or any other computing entity. Computing device 400 may be any type of computing device capable of performing the functions described herein, including compressing data, decompressing data, reading data, writing data, transmitting data, and performing processes. As shown in FIG. 4, the computing device 400 includes a central processing unit (CPU) 402, a main memory 404, an input/output (I/O) subsystem 406, communication circuitry 408, and one or more data storage devices 412. In other embodiments, the computing device may include other or additional components, such as those commonly found in a computer (e.g., display, peripheral devices, etc.). Additionally, in some embodiments, one or more of the illustrative components may be incorporated in, or otherwise form a portion of, another component. For example, in some embodiments, the main memory 404, or portions thereof, may be incorporated in the CPU 402.

The CPU 402 may be embodied as any type of processor capable of performing the functions described herein. As such, the CPU 402 may be embodied as a single or multi-core processor(s), a microcontroller, or other processor or processing/controlling circuit. In some embodiments, the CPU 402 may be embodied as, include, or be coupled to a field programmable gate array (FPGA), an application specific integrated circuit (ASIC), reconfigurable hardware or hardware circuitry, or other specialized hardware to facilitate performance of the functions described herein. The CPU 402 may include specialized compression logic 420, which may be embodied as any circuitry or device, such as an FPGA, an ASIC, or co-processor, capable of offloading, from the other components of the CPU 402, the compression of data. The main memory 404 may be embodied as any type of volatile (e.g., dynamic random access memory (DRAM), etc.) or non-volatile memory or data storage capable of performing the functions described herein. In some embodiments, all or a portion of the main memory 404 may be integrated into the CPU 402. In operation, the main memory 404 may store various software and data used during operation, such as, for example, uncompressed input data, hash table data, compressed output data, operating systems, applications, programs, libraries, and drivers. The I/O subsystem 406 may be embodied as circuitry and/or components to facilitate input/output operations with the CPU 402, the main memory 404, and other components of the computing device 400. For example, the I/O subsystem 406 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some embodiments, the I/O subsystem 406 may form a portion of a system-on-a-chip (SoC) and be incorporated, along with one or more of the CPU 402, the main memory 404, and other components of the computing device 400, on a single integrated circuit chip.

The communication circuitry 408 may be embodied as any communication circuit, device, or collection thereof, capable of enabling communications over a network between the computing device 400 and another computing device. The communication circuitry 408 may be configured to use any one or more communication technology (e.g., wired or wireless communications) and associated protocols (e.g., Ethernet, Bluetooth, RTM, Wi-Fi, WiMAX, etc.) to affect such communication.

The illustrative communication circuitry 408 includes a network interface controller (NIC) 410, which may be embodied as one or more add-in-boards, daughtercards, network interface cards, controller chips, chipsets, or other devices that may be used by the computing device 400 to connect with another computing device. In some embodiments, the NIC 410 may be embodied as part of a system-on-a-chip (SoC) that includes one or more processors, or included on a multichip package that also contains one or more processors. In some embodiments, the NIC 410 may include a processor (not shown) local to the NIC 410. In such embodiments, the local processor of the NIC 410 may be capable of performing one or more of the functions of the CPU 402 described herein.

The data storage devices 412, may be embodied as any type of devices configured for short-term or long-term storage of data such as, for example, solid-state drives (SSDs), hard disk drives, memory cards, and/or other memory devices and circuits. Each data storage device 412 may include a system partition that stores data and firmware code for the data storage device 412. Each data storage device 412 may also include an operating system partition that stores data files and executables for an operating system. In the illustrative embodiment, each data storage device 412 includes non-volatile memory. Non-volatile memory may be embodied as any type of data storage capable of storing data in a persistent manner (even if power is interrupted to the non-volatile memory). For example, in the illustrative embodiment, the non-volatile memory is embodied as Flash memory (e.g., NAND memory or NOR memory) or a combination of any of the above, or other memory. Additionally, the computing device 400 may include one or more peripheral devices 414. Such peripheral devices 414 may include any type of peripheral device commonly found in a computing device such as a display, speakers, a mouse, a keyboard, and/or other input/output devices, interface devices, and/or other peripheral devices.

While the above is a complete description of exemplary specific embodiments of the disclosure, additional embodiments are also possible. Thus, the above description should not be taken as limiting the scope of the disclosure, which is defined by the appended claims along with their full scope of equivalents.

The following Appendix, (Dictionary Match Pseudocode), contains pseudocode and related description which form integral portions of this detailed description and are incorporated by reference herein in their entirety. This Appendix contains illustrative implementations of actions described above as being performed in some embodiments. Note that the following pseudocode is not written in any particular computer programming language. Instead, the pseudocode provides sufficient information for a skilled artisan to translate the pseudocode into a source code suitable for compiling into object code.

APPENDIX
(Dictionary Match Pseudocode)

| | | | |
|---|---|---|---|
| static const uint | MinDictLen | = 4; | // Min dictionary word length |
| static const uint | MaxDictLen | = 12; | // Max dictionary word length |
| static const uint | DictBits | = 16; | // number of bits for dictionary space |
| static const uint | HashExtBits | = 1; | // extra bits to reduce Hash collision |

| | | |
|---|---|---|
| static const uint | DictMask | = (1<<DictBits) -1; // mask for dictionary index |

uint *dictHash2Ind; // map table of hashIdx -> dictID, with size of 1<<(DictBits +

| HashExtBits) | | |
|---|---|---|
| typedef struct word_dict { | | // dictionary entry |
| uint | wordLenCnt; | // [word length (4~12), reference count] |
| uint | word[3]; | // up to 12-byte word |
| uint | hashIdx; | // corresponding hash index |
| } Word_Dict; | | |
| Word_Dict | *wordDict; | // word dictionary, with size of 1<<DictBits |

| | |
|---|---|
| Struct Dict_Stat { | // dictionary status tracker |
| uint wordIndPtr; | // rotational pointer to the current word index |
| uint is Full; | // indicator of dictionary is full |
| uint useBits; | // dictionary words in use and its number of bits |

| | |
|---|---|
| } dictStat; | |
| typedef struct dict_match { | // dictionary match output |
| uint len; | // matched word length |
| uint wordInt; | // matched word index |
| Word_Dict *wordPtr; | //matched word pointer } Dict_Match; |

```
//This function attempts to insert matchStr to the dictionary void Dict_Insert (uint8
*matchStr, uint matchLen)
{
    uint i, h, *dictHashPtr;
    Word_Dict *wordDictPtr;
    uint *matchIntStr = (uint *)matchStr;
    h = hash(matchStr, matchLen);
    h = ((h \hat{ } h>>DictBits) &DictMask) <<HashExtBits;
    dcitHashPtr = dcitHash2Ind + h;
    for (i=0; ! (i>>HashExtBits); i++, dictHashPtr++) {
```

| | |
|---|---|
| if ( *dictHashPtr ) continue; | // the slot is occupied |

```
    if ( !dictStat. isFull ) {
      wordDictPtr ->word[0] = matchIntStr [0];
      wordDictPtr ->word[1] = matchIntStr [1];
      wordDictPtr ->word[2] = matchIntStr [2];
// set length in upper 8-bit and 0 reference count
wordDictPtr ->wordLenCnt = matchLen <<8;
// update useBits, which tracks the bit number of wordIntPtr
dictStat.useBits += dictStat.wordIndPtr >> dictStat.useBits;
```

| | |
|---|---|
| wordDictPtr ->hashIdx = h \hat{ } i; | // set hash index |

*dictHashPtr = dictStat.wordIndPtr;
}
else {

| | |
|---|---|
| if ( wordDictPtr ->wordLenCnt &0xFF ) | // non-zero reference count |
| wordDictPtr ->wordLenCnt --; | // decrease the reference count by 1 |

```
}
    else {   // reference count is zero, then invalidate the entry
      wordDictPtr ->word[0] = matchIntStr [0];
      wordDictPtr ->word[1] = matchIntStr [1];
      wordDictPtr ->word[2] = matchIntStr [2];
      wordDictPtr ->wordLenCnt = matchLen <<8;
```

| | |
|---|---|
| dictHash2Ind[ wordDictPtr=>hashIdx ] = 0; | //invalidate the outdated entry |
| wordDictPtr ->hashIdx = h \hat{ } i; | //set hash index |

```
      *dictHashPtr = dictStat.wordIndPtr;
      }
    }
    break;
}
if ( i>>HashExtBits ) { // all slots are fukk then update the current dictionary entry
    if ( !dictStat.isFull )
      return;
  if(wordDictPtr->wordLenCnt & 0xFF) reference count is positive then decrease it
    wordDictPtr->wordLenCnt --;
```

| | |
|---|---|
| else dictHash2Ind [ owrdDictPtr->hashIdx ] = 0; | // invalidate the outdated entry |

```
}
wordDictPtr++;
if( ++dictStat.wordIndPtr >> DictBits ) { // cyclically rotate wordDictPtr
    wordDictPtr -= DictMask;
    dictStat.wordIndPir = 1; // note zero index is reserved for fast initialization
    dictStat. IsFull = 1;
    dictStat.useBits = DictBits;
    }
}
//This function searches the dictionary to find the longest string match.
//It returns hashDict pointer and the maximum match length
void Dict_Search9uint8 *rawBufPtr, Dict_Match *dictMatch)
{
    uint i, h, hashVec[16];
    uint DictLen;
    uint *dictHashPtr;
    Word_Dict * dictPtr;
    Uint curStrInt = *(uint *) rawBufPtr;
    dictMatch->len = 0;
    hash_seq(rawBufPtr, MaxDictLen, hashVec); // compute the hash sequence
for(dictLen=MaxDictLen; dictLen>=MinDictLen; dictLen--) {
//search from max down to min
h = (hashVec[dcitLen] \hat{ } hashVec[dictLen]>>DictBits) & DictMask;
dictHashPtr = dictHash2Ind + (h<<HashExtBits);
// note hashDict is created with a small margin to avoid crossing boundary
for(i = 0; !(i>>HashExtBits); i++, dictHashPtr; {
```

| | |
|---|---|
| if ( !*dictHashPtr) continue; | // skip empty slot |

```
    dcitPtr = wordDict + *dictHashPtr;
    if (dictPtr->wordLenCnt>>8 ! = dictLen | | dictPtr->word[0] ! = curStrInt )
```

| | |
|---|---|
| continue; | // preprocessing |

```
    if ( dictLen= =4 | | 0= =memcmp (dictPtr->word+1, rawBufPtr+4; dictLen−4)) {
// matched
    dictMatch=>wordPtr = dictPtr;
    dictMatch=>wordInd = *dictHashPtr;
    dictMatch=>len = dictLen;
    return;
        }
      }
    }
}
```

I claim:

1. A method for creating entries for a dynamic dictionary of a dictionary-based data compression system, the method comprising:
receiving input data comprising an input data string;
performing a string match search over a sliding window of previous data to determine a longest string of input data matching data contained in the sliding window:
performing a dictionary search over the dynamic dictionary to determine a longest string of input data contained as a reference in the dynamic dictionary:
comparing the length of the longest string of input data matching data contained in the sliding window with the length of the longest string of input data contained as a reference in the dynamic dictionary; and
creating an entry referencing the input data string in the dynamic dictionary only if the longest string of input data matching data contained in the sliding window is greater than the longest string of input data contained as a reference in the dynamic dictionary.

2. The method of claim 1 wherein the sliding window is one of a plurality of sliding windows, each of the plurality of sliding windows having a corresponding match length.

3. The method of claim 1 wherein a smallest data string match length is two bytes.

4. The method of claim 1 wherein each of the corresponding match length has hash function based upon the match length.

5. A sliding window data compressing compression method comprising:
determining a plurality of data string match lengths
implementing a corresponding sliding window for each of the data string match lengths, a size of each of the corresponding sliding windows based upon the corresponding match length.

6. The sliding window data compressing compression method of claim 5 wherein a smallest data string match length is two bytes.

7. The sliding window data compressing compression method of claim 6 wherein each of the sliding windows has a corresponding hash chain.

8. The sliding window data compressing compression method of claim 5 wherein a search of each of the plurality of sliding windows is conducted concurrently.

9. The sliding window data compressing compression method of claim 5 wherein the sliding window method is a dictionary-based method, the method further comprising:
receiving input data comprising an input data string:
performing a string match search over each sliding window of previous data to determine a longest string of input data matching data contained in each sliding window:
performing a dictionary search over the dynamic dictionary to determine a longest string of input data contained as a reference in the dynamic dictionary:
comparing the length of the longest string of input data matching data contained in each sliding window with the length of the longest string of input data contained as a reference in the dynamic dictionary; and
creating an entry referencing the input data string in the dynamic dictionary only if the longest string of input data matching data contained in each sliding window is greater than the longest string of input data contained as a reference in the dynamic dictionary.

10. A computer program stored on a computer readable medium controlling a processing system to perform a method for a sliding window data compression process, the method comprising:
receiving input data comprising an input data string:
searching each of a plurality of sliding windows to locate a longest input data string match, each of the plurality of sliding windows having a sliding window size corresponding to one of a plurality of data string match lengths.

11. The computer program of claim 10 wherein the processing system comprises a plurality of processors, each processor concurrently performing a search of a corresponding sliding window.

12. The computer program of claim 10 wherein a smallest data string match length is two bytes.

13. The computer program of claim 10 wherein each of the sliding windows has a corresponding hash chain.

14. The computer program of claim 10 wherein the sliding window data compression process is a dictionary-based data compression process, the method further comprising:
performing a dictionary search over the dynamic dictionary to determine a longest input data string contained as a reference in the dynamic dictionary:
comparing the length of the longest input data string matching data contained in each sliding window with the length of the longest input data string contained as a reference in the dynamic dictionary; and
creating an entry referencing the input data string in the dynamic dictionary only if the longest input data string matching data contained in each sliding window is greater than the longest input data string contained as a reference in the dynamic dictionary.
